(19) United States
(12) Patent Application Publication
(10) Pub. No.: US 2008/0178093 A1
(43) Pub. Date: Jul. 24, 2008

(54) METHOD, SYSTEM AND COMPUTER PROGRAM PRODUCT FOR RESOURCE ORIENTATED MULTI-PROJECT MANAGEMENT

(75) Inventor: Claus Brandl, Pibrac (FR)

Correspondence Address: OBLON, SPIVAK, MCCLELLAND MAIER & NEUSTADT, P.C., 1940 DUKE STREET, ALEXANDRIA, VA, 22314, US

(73) Assignee: AIRBUS S.A.S, Blagnac (FR)

(21) Appl. No.: 11/626,409

(22) Filed: Jan. 24, 2007

(51) Int. Cl. G06F 3/00

(52) U.S. Cl. 715/740

(57) ABSTRACT

A method, system, and computer program product for managing projects via a web-based system. The method includes receiving a username and password for a user and determining whether the user is a first-level-access-user. After determining that the user is a first-level-access-user, displaying a field configured to receive budget-distribution information, receiving budget-distribution information inputted into the field, displaying the budget-distribution information, and saving the budget-distribution information into the web-based system. The method also includes displaying a plurality of site fields, each configured to receive and display budget information about a worksite where a project is scheduled to take place, receiving the budget information into the site fields, displaying the budget information, and saving the budget information. The method further includes displaying project information fields configured to receive and display project information about the project scheduled to take place at the worksite and receiving, displaying, and saving the project information.

### BACKGROUND OF THE INVENTION

1. Field of the Invention

The present invention relates generally to a method and system for resource orientated multi-project management, based on functionalities from plan-orientated multi-project management systems and enterprise project management systems.

2. Description of the Related Art

Modern mid-sized corporate departments are typically organized in matrix-like structures consisting of project managers in link with budget providers and clients, and group leaders who control the workforce. Planning operations for the upcoming year consists of harmonizing the available budget from various sources, projects needs, skill capabilities and skill availabilities. Furthermore, in a multi-site context, the proper budget for each activity must be allocated to the right place, often through heavy, un-harmonized, and local processes. What can typically be seen in the management of the matrix organization, is a collection of spreadsheets, where each individual has their own particular solution to their subpart of all project clusters run by this department. However, the organization is seldom harmonized and seldom up-to-date as to how individual managers are managing their part of the overall project. Even with great effort, simple questions like “who works on my project” or “on which tasks do I have to work” become difficult to answer, especially when priorities between the sub-projects change. These problems in turn lead to the exchange of even more spreadsheets, further monopolizing the precious time of managers and employees.

### SUMMARY OF THE INVENTION

Accordingly, an object of the present invention is to provide a novel method, system, and computer program product for managing projects via a web-based system. In a first embodiment, the method, system, and computer program product includes: receiving a username and password for a user and determining whether the user is a first-level-access-user (e.g. a Senior Project Manager). After determining that the user is a first-level-access-user, displaying a field configured to receive budget-distribution information, receiving budget-distribution information inputted into the field, displaying the budget-distribution information, and saving the budget-distribution information into the web-based system. The first embodiment also includes displaying a plurality of site fields, each configured to receive and display budget information about a worksite where a project is scheduled to take place, receiving the budget information into the site fields, displaying the budget information, and saving the budget information. The first embodiment further includes, displaying project information fields configured to receive and display project information about the project scheduled to take place at the worksite and receiving, displaying, and saving the project information.

The method, system, and computer program product, can further include: displaying no-site fields, and receiving into the no-site fields budget information not allocated to a specific worksite. The embodiment further includes, displaying the budget information not allocated to a specific worksite at the no-site fields, and saving the budget information not allocated to a specific worksite into the web-based system.

The method, system, and computer program product, can also display a resource pull-down menu configured to receive and display resource names, and receive a resource name from the resource pull-down menu. At least one of the project information fields can be auto-populated based on the resource name and the resource name can be displayed at the resource pull-down menu. The project information that is auto-populated can be displayed at the project information fields, and the resource name and the project information fields can be saved into the web-based system.

The method, system, and computer program product, can also include: displaying a plurality of text boxes and receiving text messages about the project inputted into the text boxes. The fourth embodiment further includes, displaying the text messages at the text boxes, and saving the text messages into the web-based system.

The method, system, and computer program product, can further include: determining from the username and the password whether the user is a second-level-access-user (e.g. a Project Manager), and after determining that the user is a second-level-access-user, receiving the budget information into the site fields and receiving the project information into the project information fields. The budget-distribution information is maintained unchanged so that the second-level-access-user has access to modify project information, but not budget-distribution information.

In the method, system, and computer program product, if the user is not a first-level-access-user nor a second-level-access-user, the user can be designated as a third-level-access-user (also known as a “Viewer”). The user is allowed to view data, but is prohibited from modifying the data.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a screen shot of the graphical user interface used in an embodiment of the present invention.

FIG. 2 illustrates a diagram of the software and hardware architecture for an embodiment of the present invention.

FIG. 3 illustrates a diagram of the software and hardware architecture for an embodiment of the present invention.

FIGS. 4A-4D show a diagram of the database architecture of an embodiment of the present invention.

FIG. 5 illustrates a screen shot of an embodiment of the present invention.

FIG. 6 illustrates the rights and privileges a third-level-access-user (i.e. Viewer) possesses.

FIG. 7 illustrates the rights and privileges a second-level-access-user (e.g. Project Manager) possesses.

FIG. 8 illustrates the rights and privileges a first-level-access-user (e.g. Senior Project Manager) possesses.

FIG. 9 illustrates a screen shot of an embodiment of the present invention.

FIG. 10 illustrates a screen shot of an embodiment of the present invention.

FIG. 11 illustrates a screen shot of an embodiment of the present invention.

FIG. 12 illustrates a screen shot of an embodiment of the present invention.

FIG. 13 illustrates a screen shot of an embodiment of the present invention.

FIGS. 14A-14E show a flow chart of an embodiment of the present invention.

### DETAILED DESCRIPTION OF THE PREFERRED EMBODIMENTS

The present invention allows for the planning of budget, workforce, and deliverables of upcoming projects. It can provide for a simple, high-level follow-up of ongoing projects. The present invention allows managers and employees to oversee clusters of projects (multi-project management systems). Further, it allows high-level, senior management oversight on projects and the workforce. The present invention can be implemented in, but is not limited to, a multi-site environment or a matrix organization (project management—skill groups). It is envisioned that the present invention can be used for, but is not limited to, the management of aircraft-related projects.

When looking at methods and tools available on the market today, there are several solutions which follow the development of projects, starting when the input is known (e.g. timing, resources, budget, deliverables), and most of these solutions only look at one project (single-project management systems) or clusters of projects (multi-project management systems). Further, these solutions do not take into account interdependencies on the workforce level with other projects via priority settings and/or a workforce shortage.

Accordingly, the present invention allows for multiple users (typically project managers and group managers) to start from a first basic input. A first input can be, but is not limited to, an estimation of the total available budget, an estimation of the budget distribution over several sites, a rough idea about the (clusters of) projects the department should work on in the next year (or any other period). Project information can then be fine-tuned concurrently as more and more information becomes available about: budget lines and the amount of budget on each line, hourly rates for internal people and subcontractors at each site, the actual projects to be run, project clusters for project managers to equal their workload (here called “sectors”), the set-up of each working team (“skill group”), who will work on which task, what will be the main deliverable, and when it is due.

At any point in time, the present invention displays the delta between budget allocation representing the request and workforce allocation, so that project managers and group leaders know the issues they have to discuss in order to achieve a harmonized view. For a mid-sized department in a large company, this process can take between four to six months using conventional tools. The present invention can significantly reduce this time. Even before a harmonized view is achieved, the present invention provides multiple views on the data as required by the business.

The present invention also allows a mid-size department (e.g., 50-300 people) to focus on the time before the project clusters start, thus allowing operational planning to commence (e.g. for the upcoming year). Further, the present invention provides the possibility to start with little top-down input, and then being able to dynamically add information with a more and more detailed bottom-up allocation of tasks. In addition, the interdependency of project clusters among common human resources is considered in the planning process (multiple project cluster functionality).

Another aspect of the present invention is that it differentiates between the budget and the project, in order to allow the best communication to outside contacts (budget providers, which can be e.g. national research “projects”) and to the inside workforce (stable business projects e.g. capability development).

The present invention may, for example, be coded as a web-based tool. The tool's architecture allows multiple users to work concurrently. Data handling is in a centralized relational database, allowing for access by further applications (e.g. interface for skillgroup managers to plan their group tasks more precisely). As a web-based tool, it can be accessed using a trans-site intranet/internet. Additional safety can be achieved using restricted access based on a role concept.

At any point in time, and independently of the degree of achieved harmonization between the top-down budget input and the bottom-up task definition, different views of the data can be obtained. The software architecture of an embodiment of the present invention allows several different ways to view project information in order to fulfill the current needs of the particular business.

An embodiment of the present invention can have the ability to display task data in a variety of ways. For example, the tasks per user in which each skill group member gets an immediate overview of his tasks for the upcoming year or the current year can be displayed. Which site works on which projects or which sectors, which skill group works for which sectors, and which new tasks still have budgeted funds remaining can be displayed. Further, detailed information showing the budget distribution per site and per budget line (internal workforce and subcontractors) can be displayed. This information is important for controlling departments so that they can initialize the correct budget distribution for each site at the beginning of the new year.

An embodiment of the present invention can also have the ability to view any other data collected which is needed by various administrative or working processes. The collected data that can be displayed includes: workforce (names), budget lines, projects (independent from budget lines), sectors (cluster of projects and cluster of budget lines), sites, teams (skill groups), and tasks with allocated budget, required workforce, effort estimation, high-level deliverables and timeplan.

An embodiment of the present invention also can provide the viewing of supporting data. The supporting data can lessen the amount of work that goes into task allocation. The supporting data need only be inputted once and can then be used by all participants in the process. The supporting data that can be viewed includes: resources (list of people, which team they are in, what site, subcontractor or internal, etc.), hourly rates per site, sites, projects, teams, budget lines, and sectors. The software architecture of an embodiment of the present invention allows for automatic updating, e.g. the resources data from other databases, if needed.

Referring now to the drawings, wherein like reference numerals designate identical or corresponding parts throughout the several views.

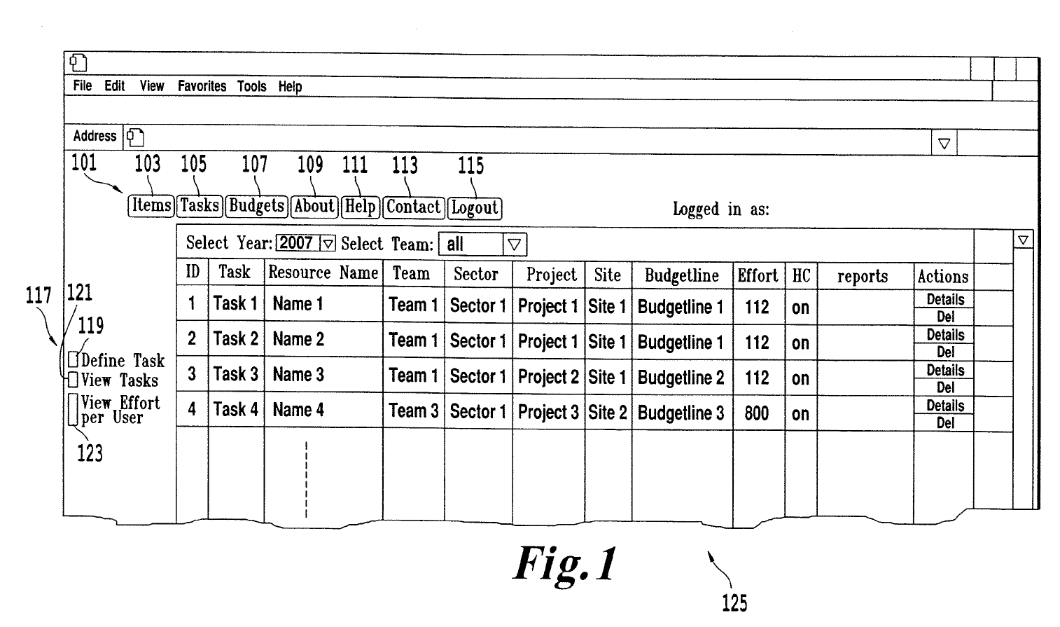

FIG. 1 illustrates a screen shot of a graphical user interface (GUI) for an embodiment of the present invention. First, the user performs a password protected login to gain access to the web-based system. With his username, a user is attributed distinctive rights via a role concept. The GUI of FIG. 1 is divided into three parts. The main chapter navigation bar 101 is located on the upper part of FIG. 1. The main chapter navigation bar 101 contains an Items tab 103, Tasks tab 105, Budgets tab 107, About tab 109, Help tab 111, Contact tab 113, and Logout tab 115. These tabs can be adjacent to each other and are horizontally arranged across the top of the GUI. Other tabs, tab names, tab configurations, and tab locations can be used.

On the left-hand side of the GUI shown in FIG. 1 is the sub-topic menu 117 which contains three sub-topic navigation tabs arranged vertically. The three sub-topic navigation tabs are: the Define Task tab 119, the View Tasks tab 121, and the View Effort Per User tab 123. The last section of the GUI shown in FIG. 1 is the Main Window 125. The Main Window 125 displays the actual contents of the GUI and allows the user to modify various information, based on the topic chosen. Distribution of sub-topic menu elements into the main chapter navigation bar 101 can be done differently. Other sub-topic menu elements can be added.

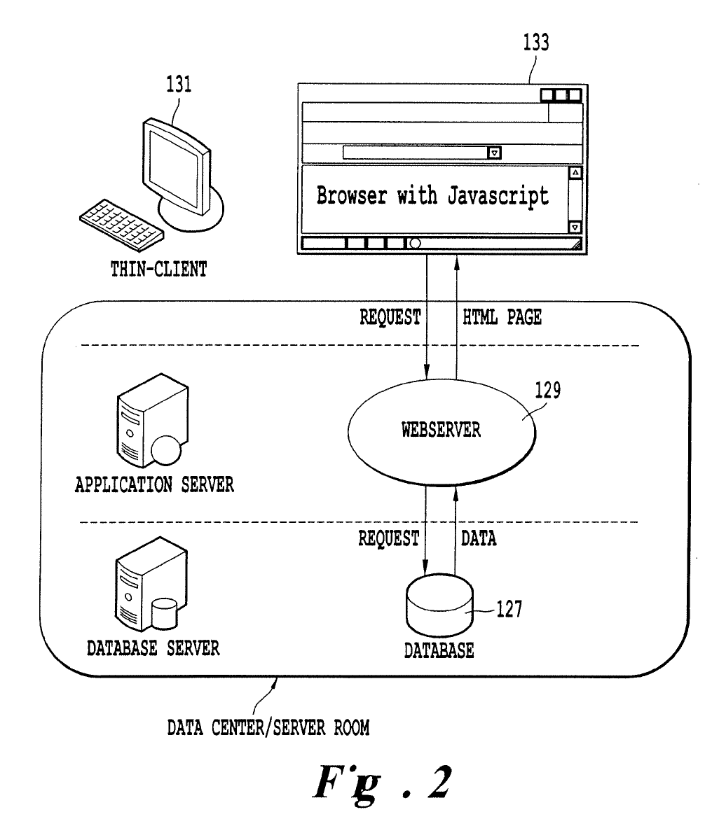

FIG. 2 illustrates a diagram of the software and hardware architecture of an embodiment of the present invention. The tool's architecture allows concurrent working for multiple users. Data handling is in a centralized relational database 127, allowing access by further applications (e.g. interface for skillgroup managers to plan their group tasks more precisely, functionality which could also be added to this embodiment). As a web-based tool, the system can be accessed using a trans-site intranet/internet. Additional safety can be achieved using restricted access based on a role concept.

FIG. 2 also shows a database 127, which could be, for example, a Transaction-safe table type InnoDB, which can maintain data integrity without data redundancies or inconsistencies. This allows a scaleable architecture, with backup ensured by standard server procedures. Furthermore, it can be open-source software (available for free). The architecture of FIG. 2 also includes a webserver 129. The webserver 129 used in an embodiment of the present invention could be, for example, an Apache HTTP webserver with PHP. Also, the webserver 129 could utilize Server Side Scripting Language, which is easy to extend.

The software and architecture of an embodiment of the present invention as shown in FIG. 2 could also use PHP Extension and Application Repository (PEAR) which is a structured library of open-source code. PEAR provides a database abstraction layer and makes future changes to the database easy. FIG. 2 also shows a thin-client 131. A thin-client can be a computer (client) in a client-server architecture network which depends primarily on a central server for processing activities. The word “thin” refers to the small boot image which such clients typically require, perhaps no more than is required to connect to a network and start up a dedicated web browser or “Remote Desktop” connection. The thin-client 131 shown in FIG. 2 may utilize any standard browser software used on a Windows or Linux based machine. Preferably, the browser 133 runs JavaScript®. The browser could also have the ability to present HTML (HyperText Markup Language) code with cascading style sheets (CSS), so that updates can be realized on a single server.

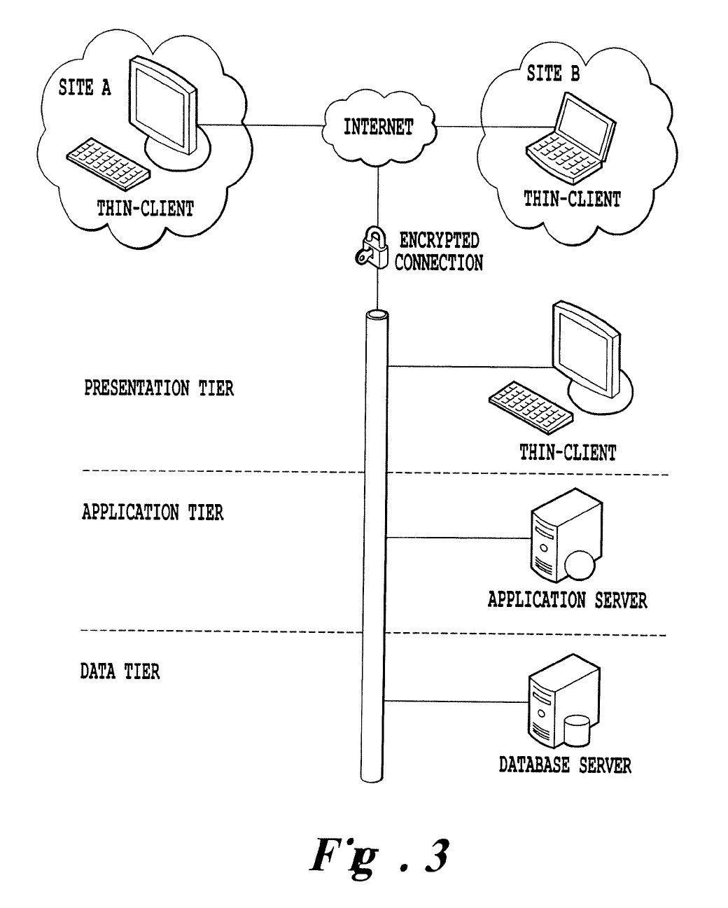

FIG. 3 illustrates a diagram of the software and hardware architecture of an embodiment of the present invention in which trans-site (worldwide) access via a secured internet connection is possible.

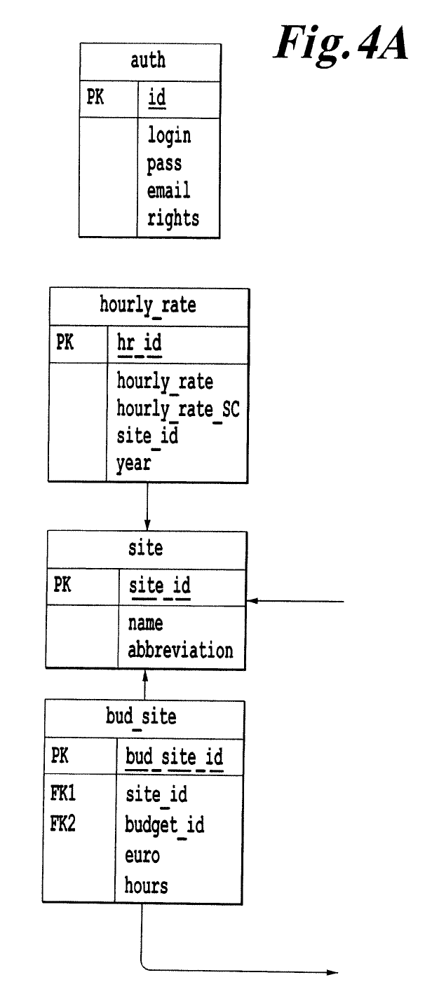

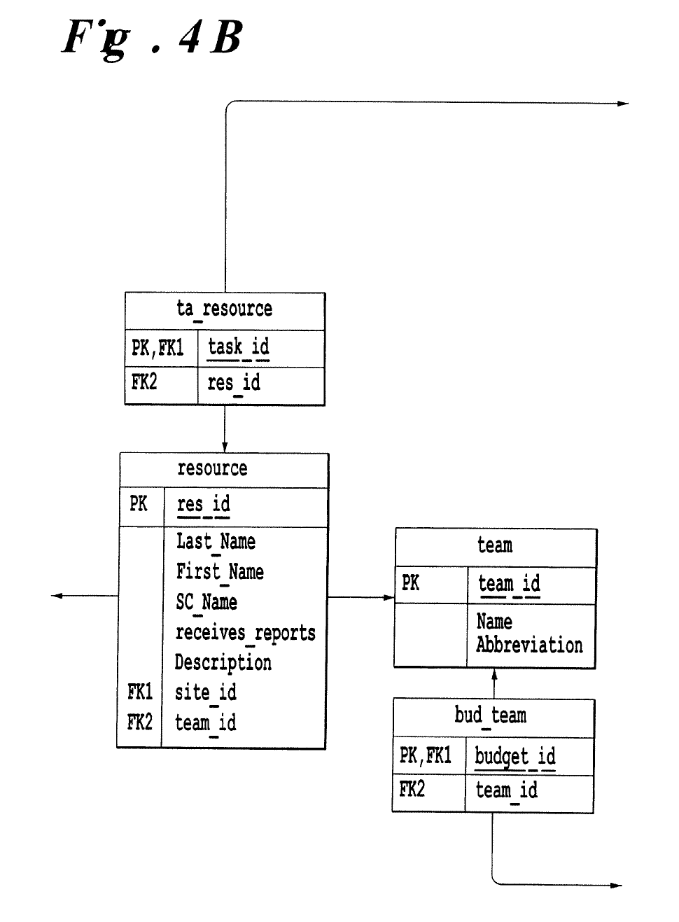

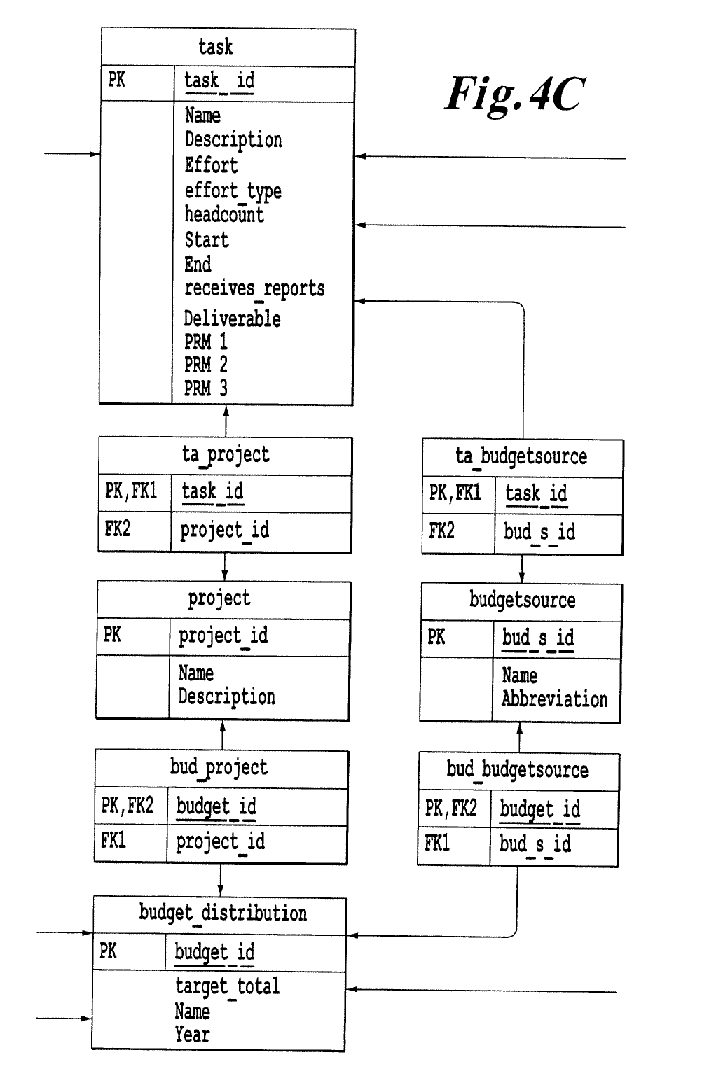

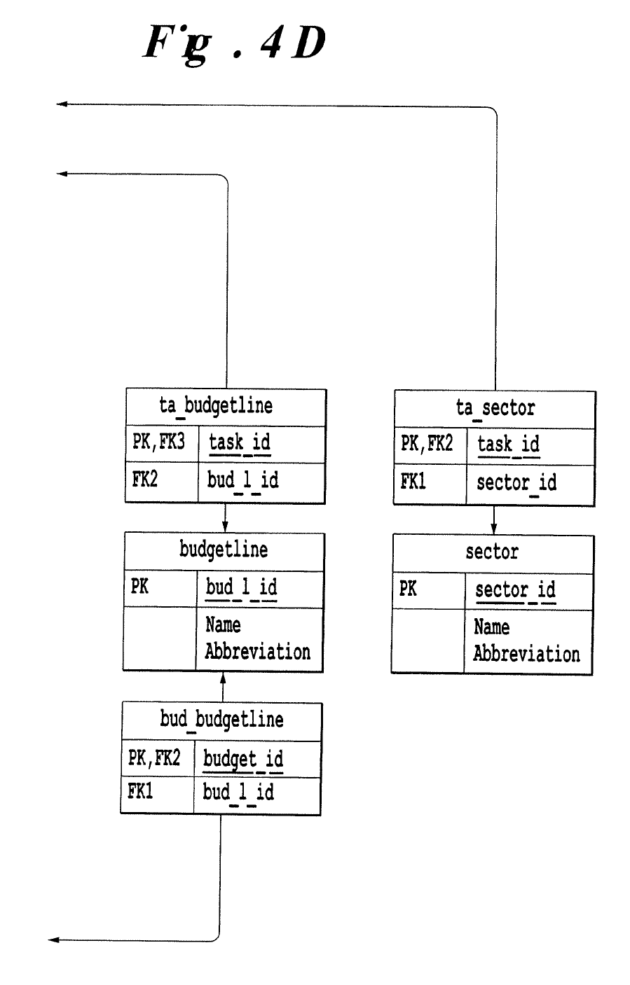

FIGS. 4A-4D show a diagram of the database architecture of an embodiment of the present invention. In FIG. 4C, for example, in the task box, PRM1, PRM2, etc. are reports from various Project Review Meetings.

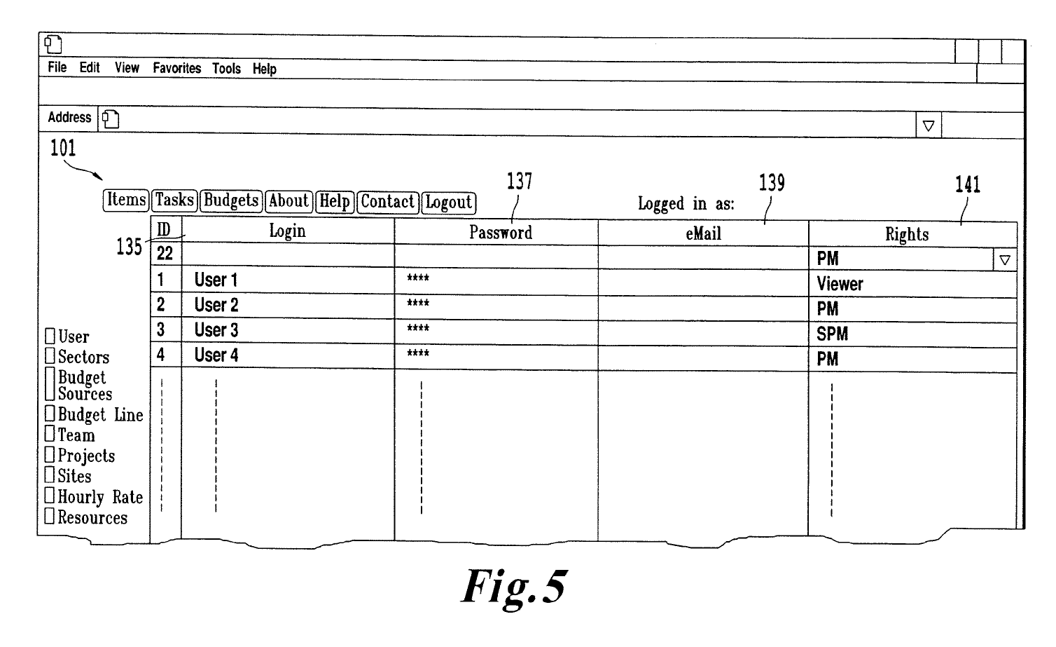

FIG. 5 illustrates a screen shot of an embodiment of the present invention. An embodiment of the present invention can use a role concept to determine the access rights of different users. A first role, called a first-level-access-user, which for instance could be a Senior Project Manager, has the right to create, change, and delete all information in the web-based system, including the initial top-down budget distribution. A second role, called a second-level-access-user, which for instance could be a Project Manager, has the right to create, change, and delete all items and distributions, apart from the initial top-down budget distribution. However, the second-level-access-user does have reading rights with respect to the initial top-down budget distribution. A third and last role, called a third-level-access-user or “Viewer” can view all task related data, but he is not allowed to change the values of any data.

The first column of FIG. 5 is a Login column 135 that lists the login information of different users. The second column is a Password column 137 that lists the corresponding password information for each user, however the actual passwords of individuals may not be available to all users. The third column is an Email column 139 which lists the email addresses of the individual users listed under the Login column 135. The fourth column is the Rights column 141 which displays whether a particular user has the rights of a SPM (Senior Project Manager or first-level-access-user), PM (Project Manager or second-level-access-user), or a Viewer (third-level-access-user). FIG. 5 also displays the main chapter navigation bar 101 on the top of the screen, providing the ability to navigate to different screens. Further, FIG. 5 shows multiple tabs arranged vertically on the left-hand side of the screen. These tabs allow a user to navigate to different menus about the subtopics shown on the tabs. The subtopics shown in FIG. 5 are: User, Sectors, Budget Sources, Budget Line, Team, Projects, Sites, Hourly Rate, and Resources. Other tabs, tab names and configurations, and column headings and configurations, can be used. Other roles and related access rights can be defined.

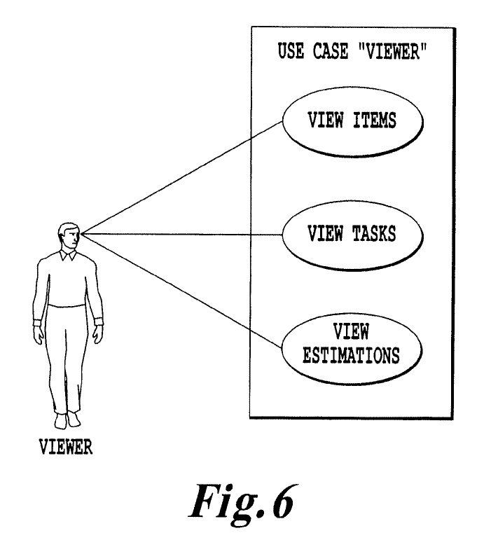

FIG. 6 illustrates the rights and privileges a third-level-access-user (i.e. Viewer) possesses. For example, a Viewer can view items, view tasks, and view estimations.

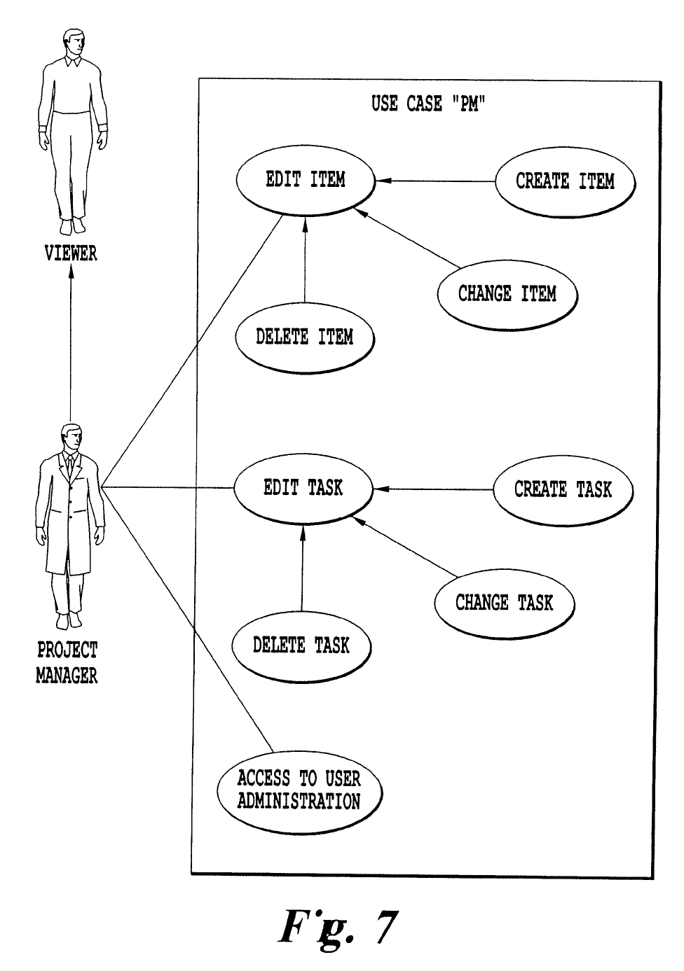

FIG. 7 illustrates the rights and privileges a second-level-access-user (e.g. Project Manager) possesses. For example, a Project Manager can edit items and tasks, delete items and tasks, create items and tasks, change items and tasks, and has access to user administration.

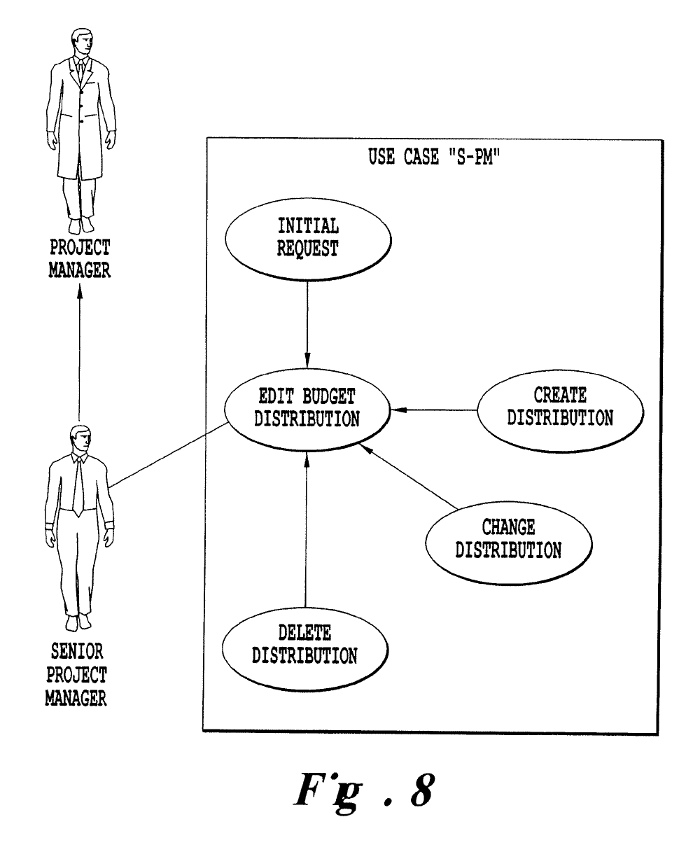

FIG. 8 illustrates the rights and privileges a first-level-access-user (e.g. Senior Project Manager) possesses. For example, a Senior Project Manager can make an initial request, edit budget distribution, create distribution, change distribution, and delete distribution.

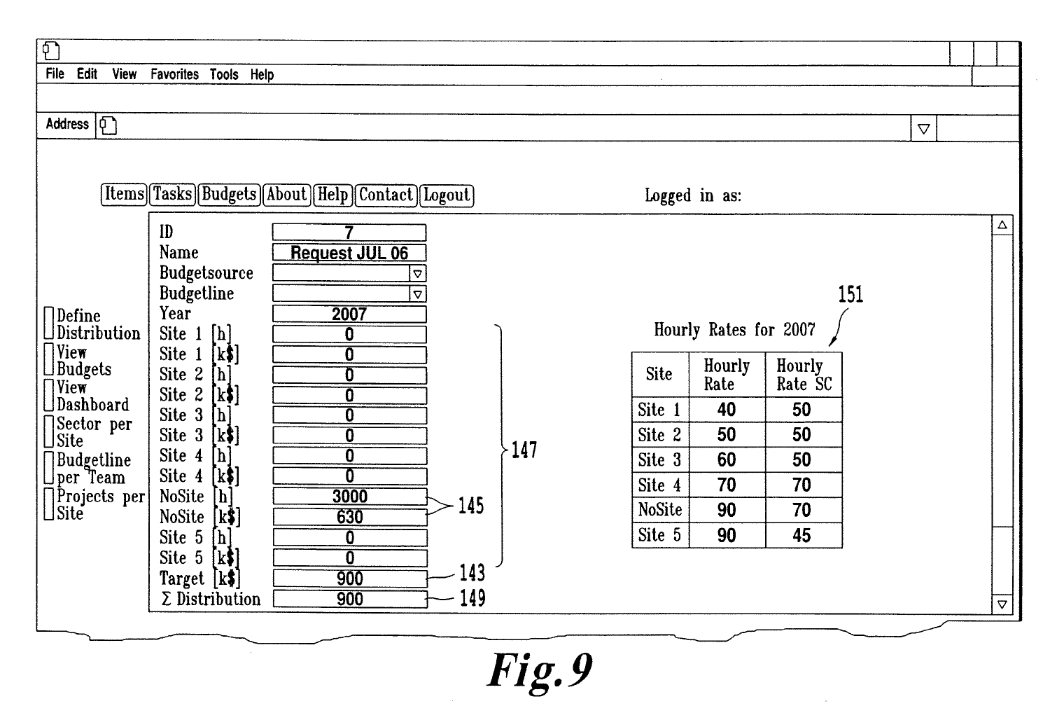

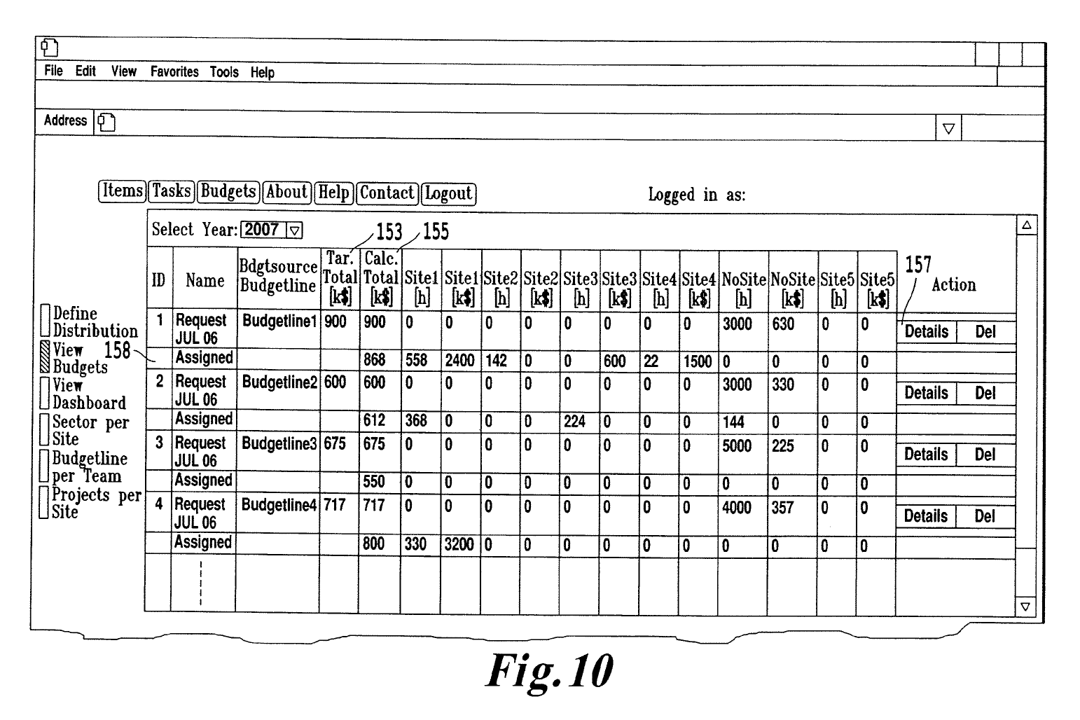

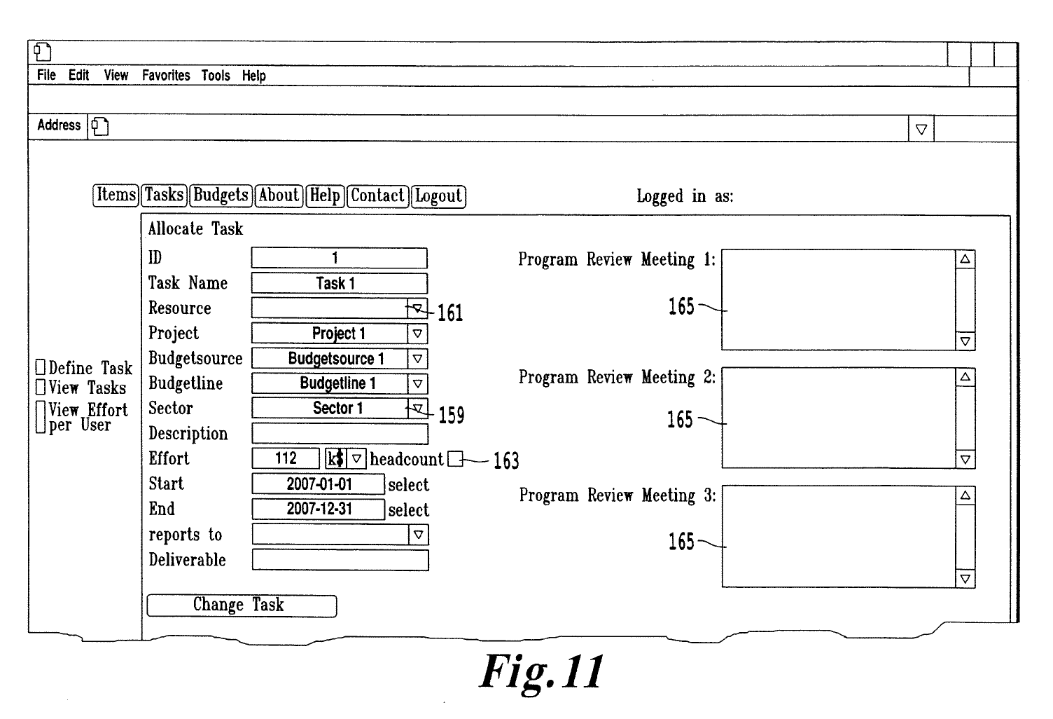

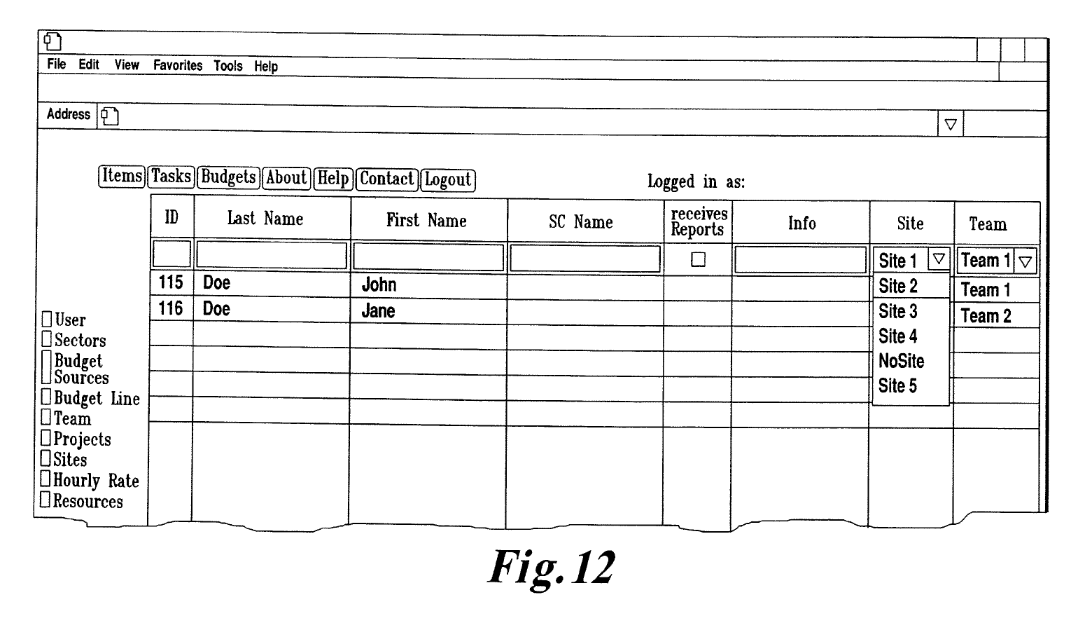

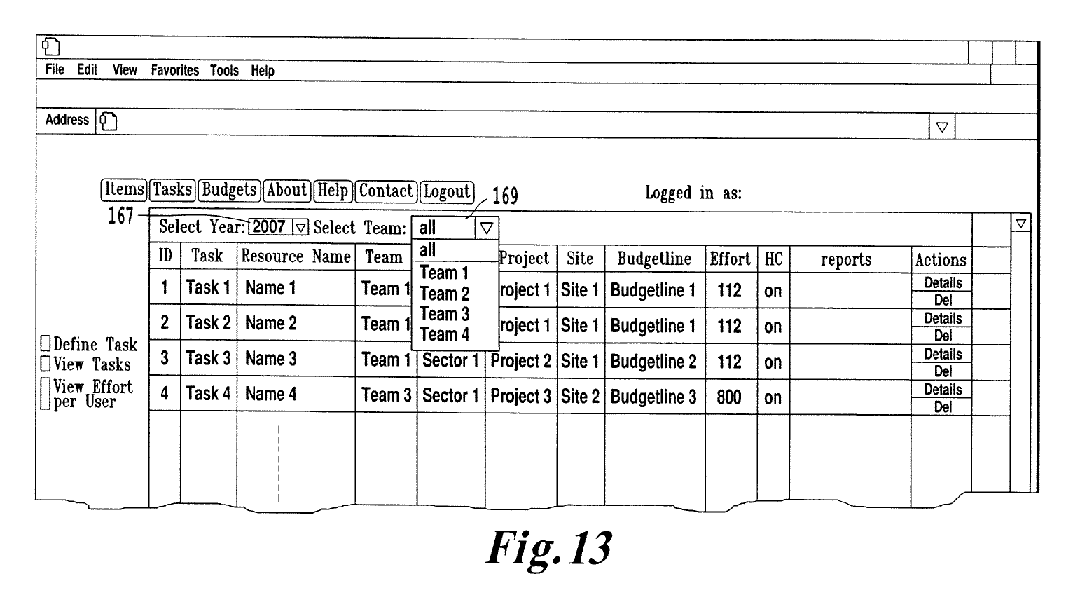

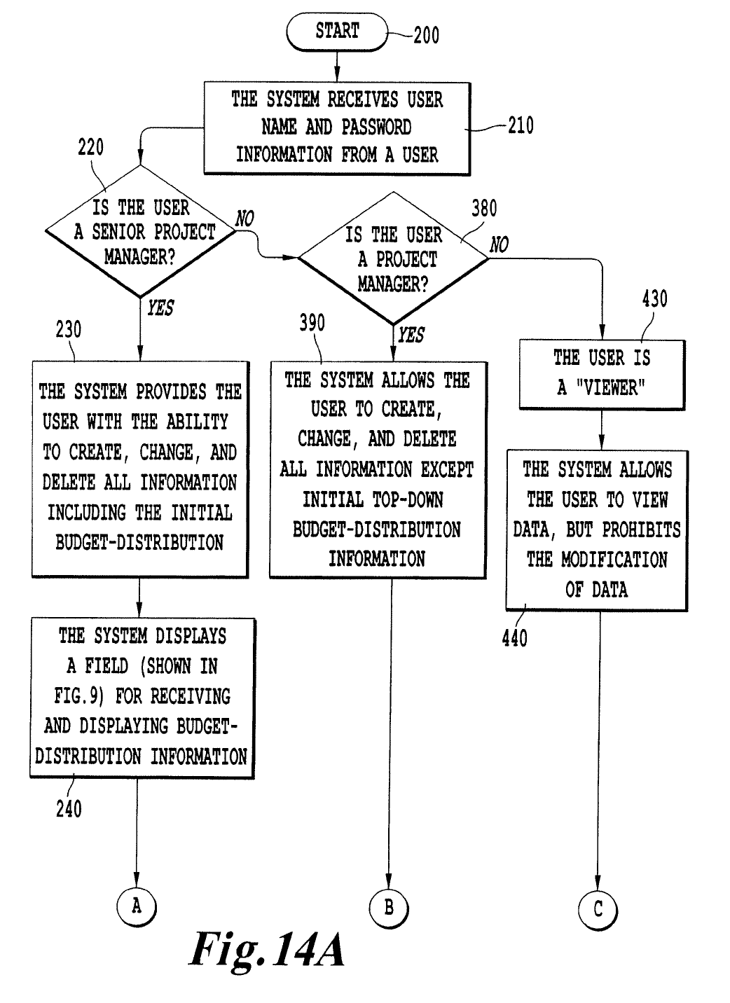

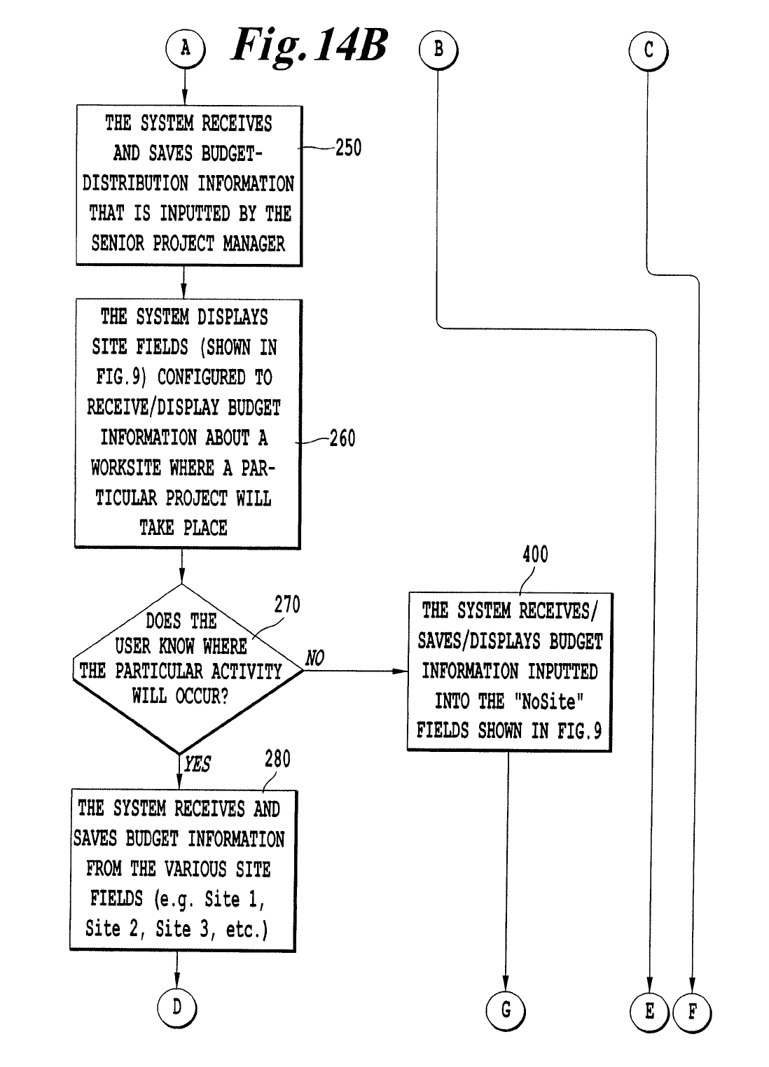

FIG. 9 illustrates a screen shot of an embodiment of the present invention. This screen shot shows a use case example of planning for the upcoming year. A use case is a technique for capturing functional requirements of systems and systems-of-systems. Each use case provides one or more scenarios that convey how the system should interact with the users or actors to achieve a specific business goal or function.

When planning for the upcoming year, the first step is that a Senior Project Manager receives first input on the potential budget for the next year and inputs the initial budget information into the Target field 143 shown in FIG. 9. The Senior Project Manager can use the NoSite fields 145 if he does not yet know where the activity will most likely be done. If he already knows at which site the activity will or is likely to take place, he can enter budget information into the particular Site fields 147 (Site 1, Site 2, Site 3, Site 4, Site 5). The Site fields 147 (Site 1, Site 2, Site 3, Site 4, Site 5) represent different locations where a project or activity may take place. The result of the Senior Project Managers current budget distribution can be seen in the Distribution field 149. The Distribution field 149 value is determined by the hourly rates for an internal and external (subcontracted) workforce and the Dollar amounts entered into the Site fields 147. The different hourly rates for various sites are displayed in the Hourly Rate table 151. Target field 143 and Distribution filed 149 can be different on purpose, e.g. to provide for reserves.

The second step is that multiple Senior Project Managers enter the budget information they have available to them, and an overview table, shown in FIG. 10, shows the current target status for a “bottom-up” approach, which sums up the assigned tasks. A “bottom-up” approach is what happens when a task is further defined. In a “top-down” approach, Senior Project Managers define the budget distribution (given from outside constraints or just as a sum with distribution flexibility). The Target Total column 153 shows the target budget for each particular project and the Calculated Total column 155 shows the total budget already allocated and entered into the system. The values in the Target Total column 153 can be added to arrive at a total target budget number for all projects. Similarly, all of the values in the Calculated Total column 155 can be added to arrive at the total allocated budget of all projects already entered into the system. Clicking on the Details tab 157 takes the user back to the budget distribution definition as shown in the screen shot of FIG. 9.

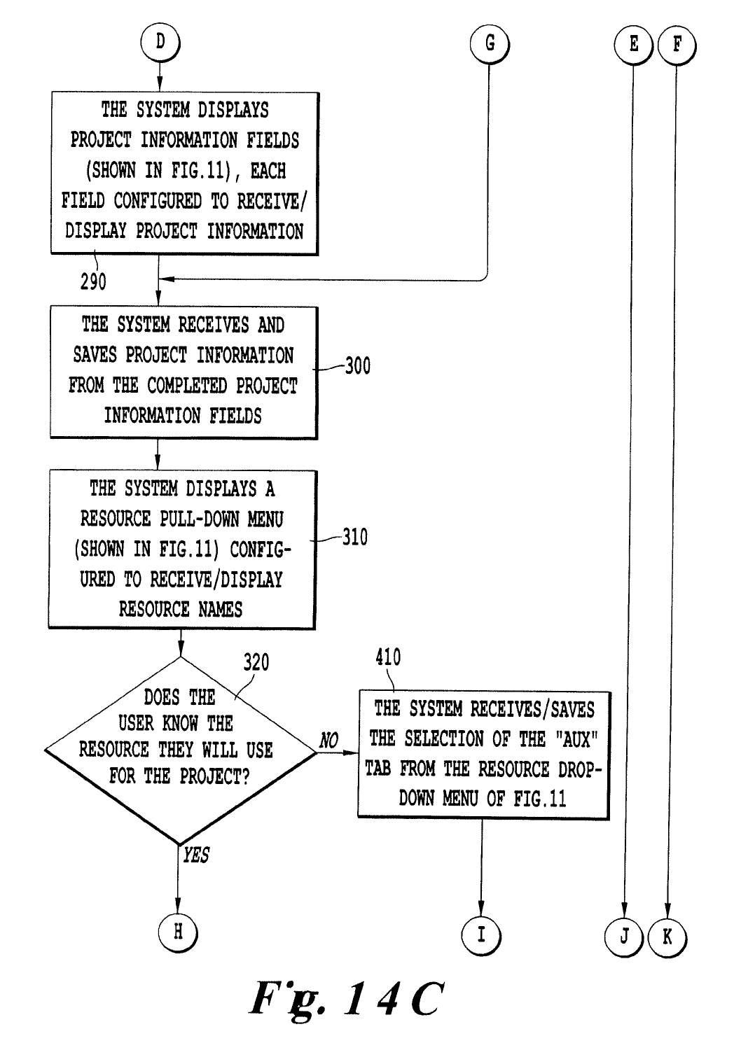

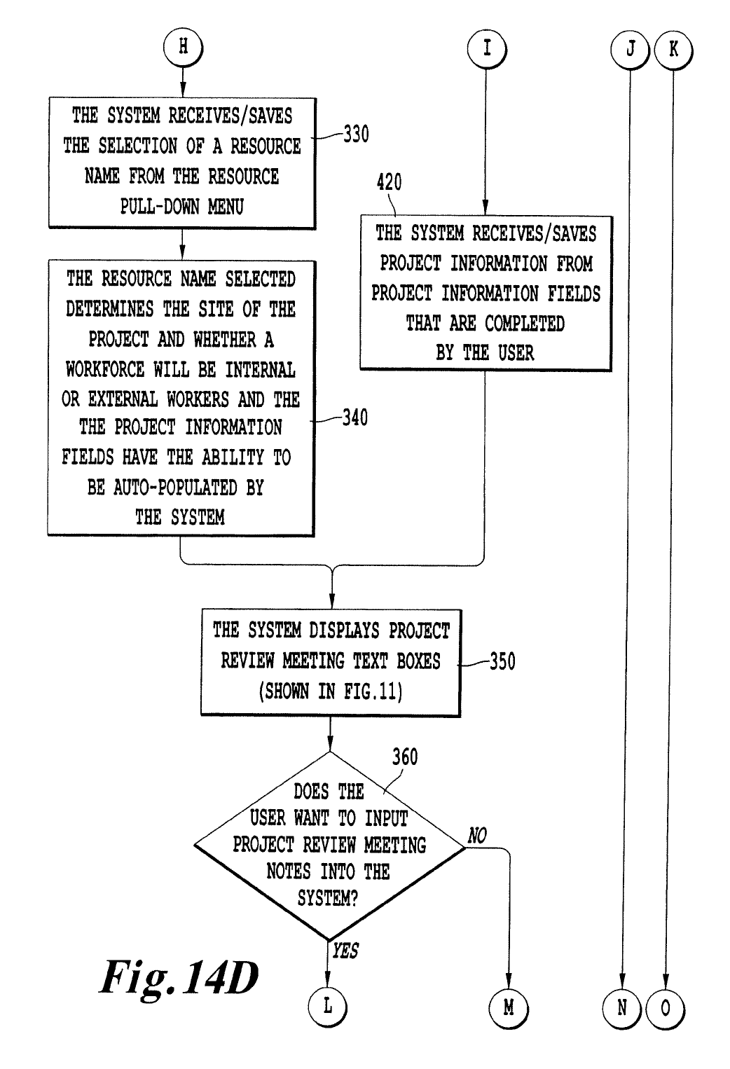

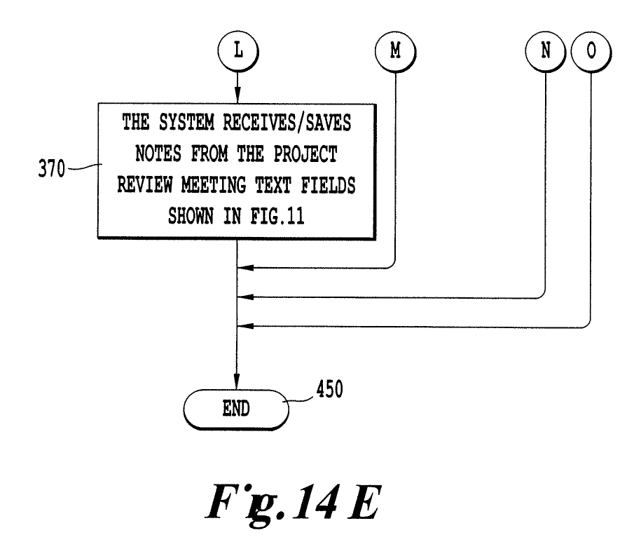

In the third step, in the screen shot of FIG. 11, a sector project manager, responsible for a cluster of projects (called a “Sector,”) indicates about what activities will be required in the upcoming year in order to progress his projects. However, this step could be performed earlier. The Sector in charge of a given project can be selected from the Sector pull-down menu 159 shown in FIG. 11. If the user already has an idea about the name of the resource they will use, they can select the resource's name from the Resource pull-down menu 161.

If the user does not know the resource they will use for a project, they can use the “AUX” (auxiliary name) function. The AUX function allows a user to sum up a project while not fully identifying defined tasks, and prepare to define it later in detail, e.g. after discussions with the skill group leaders. This allows compatibility with the (theoretical) task distribution within a matrix organization, where the project manager defines the “what” and “when,” and the skill group leader defines the “who,” “how,” and “where.” The Resource pull-down menu 161 includes AUX-resources for each site, and AUX-NoSite resources to allow a step-wise approach from little to full task allocation.

The resource selection also defines the particular site and whether the workforce will be internal or external. External/subcontractors efforts are estimated in Dollars, while internal workforce efforts are estimated with hours. A Headcount box 163 allows a user to decide if the task at hand should be considered in the headcount for the department. This feature is needed to treat special cases such as when students are working on projects. The headcount attribute could also be assigned to the resource itself rather than the task, depending on the process needs. FIG. 1 also shows the headcount feature. In that figure, the “HC” column shows the status of the headcount feature for various tasks. For example, FIG. 1 shows that the headcount feature is on.

Projects are typically divided in phases (e.g. separated by milestones) in order to manage their complexity. For a high level overview, three Program Review Meeting text boxes 165, shown in FIG. 11, are provided for the summary of Program Review Meeting (PRM) conclusions. Any other number of text boxes for this purpose can be provided. A HTML (HyperText Markup Language) link can be copied into the Program Review Meeting text boxes 165, linking, for example, minutes of meetings.

The screen shot of FIG. 11 displays several other information fields and pull-down menus. The information fields that are displayed are the ID field, Task Name field, Description field, Effort field, Start Date field, End Date field, and Deliverable field. The other pull-down menus that are displayed are the Project, Budgetsource, Budgetline, and Reports To pull-down menus.

FIG. 12 illustrates a screen shot of an embodiment of the present invention. The screen shot shows a pull-down menu in which a particular site can be selected. Another pull-down menu is shown in which a particular team can be selected.

In the fourth step, in the screen shot of FIG. 13, as Sector Project Managers continually enter information for all their projects, the overview table shown in FIG. 13 shows the current task allocation status of the bottom-up approach. When viewing the information displayed in FIG. 13, the information can be filtered by year using the Select Year pull-down menu 167. The user can select the current year for high-level follow-up or an upcoming year in order to plan future projects. The Select Year pull-down menu 167 allows a user to easily switch between years while also limiting the amount of information displayed. Furthermore, the information displayed in FIG. 13 can also be filtered by skill group (team) using the Select Team pull-down menu 169. Clicking on the details tab shown in FIG. 13 takes the user back to the budget distribution definition shown in FIG. 11.

In FIG. 10, the Assigned row 158 sums up the budget and hours from each task. The Assigned row 159 allows a user to view, at a high level, the degree of convergence between the top-down and bottom-up approach.

FIGS. 14A-14E show a flow chart of an embodiment of the present invention. Step 200 indicates the start of the flow chart. In step 210, the system receives the username and password information from a user. In step 220, the system determines based on the username and password, whether the user is a Senior Project Manager (or another first-level-access-user). If the user is a Senior Project Manager, in step 230, the system provides the user with the ability to create, change, and delete all information including the initial-budget distribution. The rights and privileges granted in step 230 are the same rights and privileges shown in FIG. 8. In step 240, the system displays a field (e.g., the Target field 143 shown in FIG. 9) for receiving and displaying budget-distribution information.

In step 250, the system receives budget-distribution information that is inputted into the Target field 143 by the Senior Project Manager. The system then saves the budget-distribution information and displays the budget distribution information that has just been inputted in the Target field 143. Next, in step 260, the system displays site fields 147, e.g., shown in FIG. 9, configured to receive and display budget information about a worksite where a particular project will take place. In step 270, the user determines whether they know where the particular activity (project, etc.) will take place. If the user knows where the particular activity will take place, in step 280 the system receives budget information from the various site fields. For example, if the user knows that a project will take place at Site 1, he would enter the budget information for the project that will take place at Site 1 into the Site 1 field. This inputted information is then displayed at the Site fields 147 and saved by the system.

In step 290, the system displays project information fields (the ID, Task Name, Resource, Project, Budgetsource, Budgetline, Sector, Description, Effort, headcount, Start, End, Reports to, and deliverable fields shown in FIG. 11). The project information fields are each configured to receive and display project information. In step 300, the system receives project information from the project information fields that were filled in by the user. The information that is inputted into the system is then displayed at the corresponding project information fields and saved by the system.

In step 310, the system displays the Resource pull-down menu 161 (shown in FIG. 11). The Resource pull-down menu 161 is configured to receive and display the names of resources. The names displayed could be the names of individual people. In step 320, if the user knows which resource they will be using for the particular project, the user proceeds to step 330. In step 330, the system receives the selection of a resource name that was selected by the user from the Resource pull-down menu 161. Then the system saves the selection and displays the resource that was selected in the Resource pull-down menu 161.

Next, in step 340, the resource name selected from the Resource pull-down menu 161 determines the site of the project and whether a workforce will be internal or external (subcontractors). Consequently, based on the selection of the resource name, certain project information fields (e.g. any of the fields shown in FIG. 11) may be auto-populated by the system. The information that is auto-populated is saved and the changes are displayed in the appropriate project information fields that have been changed.

In step 350, the system displays the Program Review Meeting text boxes 165 shown in FIG. 11. In step 360, if the user wants to input the project review meeting notes into the system for others to view, the user proceeds to step 370. In step 370, the system receives notes, comments, hyperlinks, etc. from the Program Review Meeting text boxes 165, which were inputted into the Program Review Meeting text boxes 165 by the user. The system then saves this inputted information and the newly updated information is displayed in the Program Review Meeting text boxes 165.

The above steps describe the various actions a Senior Project Manager (or other first-level-access-user) can do while planning for an upcoming project or modifying an existing project or task. In step 380, the system determines if the user is a Project Manager or any other second-level-access-user. If the user is a Project Manager, in step 390 the system allows the user to create, change, and delete information except for the initial top-down budget distribution. The rights and privileges of the Project Manager are further illustrated in FIG. 7.

If the system determines in step 220 that the user is not a Senior Project Manager and in step 380 further determines that the user is not a Project Manager, the system in step 430 then designates the user as a “Viewer.” A Viewer could be any third-level-access-user. In step 440, the system allows the user to view data, but prohibits the modification of data. FIG. 6 further illustrates the rights and privileges a Viewer possesses.

If, in step 270, the user does not know where a particular activity (project, etc.) will take place, the user proceeds to step 400. In step 400, the system receives budget information from the NoSite fields 145 (e.g., shown in FIG. 9) after the user has inputted budget information into the NoSite fields 145. The system then saves the inputted information in the system and displays the updated information in the NoSite fields 145 so that other users may view the updated information.

If, in step 320, the user does not know the resource they will use for the project, the user proceeds to step 410. In step 410, the system receives the selection of the “AUX” tab from the Resource pull-down menu 161 (shown in FIG. 11) after the user has selected the “AUX” tab. As mentioned earlier, the AUX function allows a user to sum up a project while not fully identifying defined tasks, and prepare to define it later in detail, e.g. after discussions with the skill group leaders. This allows compatibility with the (theoretical) task distribution within a matrix organization, where the project manager defines the “what” and “when,” and the skill group leader defines the “who,” “how,” and “where.” The system then saves the user's selection of the “AUX” tab from the Resource pull-down menu 161 and displays the user's selection in the Resource pull-down menu 161.

After step 410, in step 420, the system receives project information entered into the project information fields (e.g. any of the fields shown in FIG. 11) by the user. The information inputted into the project information fields by the user is then saved by the system. Next, the updated information is displayed so that other users can view the changes.

Step 450 indicates the end of the flow chart and at this point after the user is done modifying or viewing information, and the user logs off the system. The user can log off the system by clicking on the Logout tab 115.

Obviously, numerous modifications and variations of the present invention are possible in light of the above teachings. It is therefore to be understood that within the scope of the appended claims, the invention may be practiced otherwise than as specifically described herein.

1. A method of managing projects via a web-based system, the method comprising:
receiving a username of a user and a password for said user;
determining from the username and said password whether the user is a first-level-access-user; and
after determining that said user is a first-level-access-user by said web-based system,
displaying a field configured to receive budget-distribution information,
receiving said budget-distribution information inputted into said field,
displaying said budget-distribution information at said field,
saving said budget-distribution information into said web-based system,
displaying a plurality of site fields, each being configured to receive and display budget information about a worksite where a project is scheduled to take place,
receiving said budget information into said site fields,
displaying said budget information at said site fields,
saving said budget information into said web-based system,
displaying a plurality of project information fields, each being configured to receive and display project information about said project scheduled to take place at said worksite,
receiving said project information into said project information fields,
displaying said project information at said project information fields, and
saving said project information into said web-based system.

2. A method according to claim 1, further comprising:
displaying no-site fields;
receiving, into said no-site field, budget information not allocated to a specific worksite;
displaying said budget information not allocated to a specific worksite at said no-site field; and
saving said budget information not allocated to a specific worksite into said web-based system.

3. A method according to claim 1, further comprising:
displaying a resource pull-down menu configured to receive and display resource names;
receiving a resource name from said resource pull-down menu;
auto-populating at least one of said project information fields based on said resource name;
displaying said resource name at said resource pull-down menu;
displaying said project information that is auto-populated at said project information fields; and
saving said resource name and said project information fields into said web-based system.

4. A method according to claim 1, further comprising:
displaying a resource pull-down menu configured to receive and display resource names;
receiving an auxiliary selection from said resource pull-down menu;
displaying said auxiliary selection at said resource pull-down menu;
receiving said project information into said project information field;
displaying said project information at said project information fields; and
saving said auxiliary selection and said project information fields into said web-based system.

5. A method according to claim 1, further comprising:
displaying a plurality of text boxes;
receiving text messages about said project inputted into said text boxes;
displaying said text messages at said text boxes; and
saving said text messages into said web-based system.

6. A method according to claim 1, further comprising:
displaying a table configured to store hourly rates for said worksites.

7. A method according to claim 1, wherein said project information includes information common to a cluster of projects and said project information fields displaying a sector pull-down menu configured to receive and display sector names of individuals responsible for said cluster of projects;
receiving a sector name from said sector pull-down menu;
displaying said sector name at said sector pull-down menu; and
saving said sector name into said web-based system.

8. A method according to claim 1, further comprising:
determining from said username and said password whether said user is a second-level-access-user; and
after determining that said user is a second-level-access-user,
receiving said budget information into said site fields and receiving said project information into said project information fields, and maintaining said budget-distribution information unchanged so that said second-level-access-user has access to modify said project information, but not said budget-distribution information.

9. A method according to claim 1, wherein said projects are aircraft related projects.

10. A method according to claim 8, further comprising:
if said user is not said first-level-access-user nor said second-level-access-user,
designating said user as a third-level-access-user,
allowing said user to view data, and
prohibiting modification of data.

11. A computer program product for managing projects, said computer program product being configured to store program instructions for execution on a computer system enabling the computer system to perform the steps of:
receiving a username of a user and a password for said user;
determining from the username and said password whether the user is a first-level-access-user; and
after determining that said user is a first-level-access-user by said web-based system,
displaying a field configured to receive budget-distribution information,
receiving said budget-distribution information inputted into said field,
displaying said budget-distribution information at said field,
saving said budget-distribution information into said web-based system,
displaying a plurality of site fields, each being configured to receive and display budget information about a worksite where a project is scheduled to take place,
receiving said budget information into said site fields,
displaying said budget information at said site fields,
saving said budget information into said web-based system,
displaying a plurality of project information fields, each being configured to receive and display project information about said project scheduled to take place at said worksite,
receiving said project information into said project information fields,
displaying said project information at said project information fields, and
saving said project information into said web-based system.

12. The computer program product of claim 11, further comprising:
displaying no-site fields;
receiving, into said no-site field, budget information not allocated to a specific worksite;
displaying said budget information not allocated to a specific worksite at said no-site field; and
saving said budget information not allocated to a specific worksite into said web-based system.

13. The computer program product of claim 11, further comprising:
displaying a resource pull-down menu configured to receive and display resource names;
receiving a resource name from said resource pull-down menu;
auto-populating at least one of said project information fields based on said resource name;
displaying said resource name at said resource pull-down menu;
displaying said project information that is auto-populated at said project information fields; and
saving said resource name and said project information fields into said web-based system.

14. The computer program product of claim 11, further comprising:
displaying a resource pull-down menu configured to receive and display resource names;
receiving an auxiliary selection from said resource pull-down menu;
displaying said auxiliary selection at said resource pull-down menu;
receiving said project information into said project information field;
displaying said project information at said project information fields; and
saving said auxiliary selection and said project information fields into said web-based system.

15. The computer program product of claim 11, further comprising:
displaying a plurality of text boxes;
receiving text messages about said project inputted into said text boxes;
displaying said text messages at said text boxes; and
saving said text messages into said web-based system.

16. The computer program product of claim 11, further comprising:
determining from said username and said password whether said user is a second-level-access-user; and
after determining that said user is a second-level-access-user,
receiving said budget information into said site fields and receiving said project information into said project information fields, and maintaining said budget-distribution information unchanged so that said second-level-access-user has access to modify said project information, but not said budget-distribution information.

17. The computer program product of claim 11, wherein said projects are aircraft related projects.

18. The computer program product of claim 16, further comprising:
if said user is not said first-level-access-user nor said second-level-access-user,
designating said user as a third-level-access-user,
allowing said user to view data, and
prohibiting modification of data.

19. A system for managing projects via a web-based system, the system comprising:
means for receiving a username of a user and a password for said user;
means for determining from the username and said password whether the user is a first-level-access-user; and
after determining that said user is a first-level-access-user by said web-based system,
means for displaying a field configured to receive budget-distribution information,
means for receiving said budget-distribution information inputted into said field,
means for displaying said budget-distribution information at said field,
means for saving said budget-distribution information into said web-based system,
means for displaying a plurality of site fields, each being configured to receive and display budget information about a worksite where a project is scheduled to take place,
means for receiving said budget information into said site fields,
means for displaying said budget information at said site fields,
means for saving said budget information into said web-based system,
means for displaying a plurality of project information fields, each being configured to receive and display project information about said project scheduled to take place at said worksite,
means for receiving said project information into said project information fields,
means for displaying said project information at said project information fields, and
means for saving said project information into said web-based system.

20. The system of claim 19, further comprising:
means for displaying no-site fields;
means for receiving, into said no-site field, budget information not allocated to a specific worksite;
means for displaying said budget information not allocated to a specific worksite at said no-site field; and
means for saving said budget information not allocated to a specific worksite into said web-based system.

21. The system of claim 19, further comprising:
means for displaying a resource pull-down menu configured to receive and display resource names;
means for receiving a resource name from said resource pull-down menu;
means for auto-populating at least one of said project information fields based on said resource name;
means for displaying said resource name at said resource pull-down menu;
means for displaying said project information that is auto-populated at said project information fields; and
means for saving said resource name and said project information fields into said web-based system.

22. The system of claim 19, further comprising:
means for displaying a resource pull-down menu configured to receive and display resource names;
means for receiving an auxiliary selection from said resource pull-down menu;
means for displaying said auxiliary selection at said resource pull-down menu;
means for receiving said project information into said project information field;
means for displaying said project information at said project information fields; and
means for saving said auxiliary selection and said project information fields into said web-based system.

23. The system of claim 19, further comprising:
means for displaying a plurality of text boxes;
means for receiving text messages about said project inputted into said text boxes;
means for displaying said text messages at said text boxes; and
means for saving said text messages into said web-based system.

24. The system of claim 19, further comprising:
means for determining from said username and said password whether said user is a second-level-access-user; and
after determining that said user is a second-level-access-user,
means for receiving said budget information into said site fields and receiving said project information into said project information fields, and maintaining said budget-distribution information unchanged so that said second-level-access-user has access to modify said project information, but not said budget-distribution information.

25. The system of claim 19, wherein said projects are aircraft related projects.

26. The system of claim 24, further comprising:
if said user is not said first-level-access-user nor said second-level-access-user,
means for designating said user as a third-level-access-user,
means for allowing said user to view data, and
means for prohibiting modification of data.
